(19) United States
(12) Patent Application Publication
(10) Pub. No.: US 2015/0138075 A1
(43) Pub. Date: May 21, 2015

(54) RECOGNITION DEVICE, RECOGNITION METHOD, COMPUTER PROGRAM PRODUCT, AND TERMINAL DEVICE

(71) Applicant: KABUSHIKI KAISHA TOSHIBA, Tokyo (JP)

(72) Inventors: Toshiaki NAKASU, Tokyo (JP); Tsukasa IKE, Tokyo (JP); Kazushige OUCHI, Saitama (JP); Yasunobu YAMAUCHI, Yokohama (JP)

(21) Appl. No.: 14/546,110

(22) Filed: Nov. 18, 2014

(30) Foreign Application Priority Data
Nov. 20, 2013 (JP) 2013-240405

(51) Int. Cl. G06F 3/01

(52) U.S. Cl. CPC G06F 3/017; G06F 3/011
USPC 345/156

(57) ABSTRACT

According to an embodiment, a recognition device includes an obtaining unit, a selection action recognizing unit, and an output unit. The obtaining unit is configured to obtain a measured value according to an action of a target for measurement. The measured value is measured by a measuring device attached to a specific body part of the target for measurement. The selection action recognizing unit is configured to, based on an acceleration of the specific body part as obtained from the measured value, recognize that a selection action has been performed for selecting any one target for operations included in a screen area. The output unit is configured to, in a state in which the selection action has been performed, output information about an operation state of the target for operations based on an amount of change in a tilt of the specific body part as obtained from the measured value.

### CROSS-REFERENCE TO RELATED APPLICATION

This application is based upon and claims the benefit of priority from Japanese Patent Application No. 2013-240405, filed on Nov. 20, 2013; the entire contents of which are incorporated herein by reference.

### FIELD

Embodiments described herein relate generally to a recognition device, a recognition method, a computer program product, and a terminal device.

### BACKGROUND

Typically, a technology is available in which, based on the measured values obtained from a sensor that is attached to a specific body part such as an arm (a wrist) of a user, the actions of the corresponding hand or fingers of the user are recognized. In such a technology, a pointer placed on the screen of a person computer (PC) is moved, and processing is performed with respect to an object that corresponds to the position of the pointer.

As far as the possible processing with respect to an object is concerned, sometimes a plurality of types of processing is available. In such a case, a menu screen is displayed to allow the user to select the desired processing. However, if the menu screen gets displayed every time some sort of processing is performed, then the operations become complicated thereby causing an increase in the burden on the user.

### BRIEF DESCRIPTION OF THE DRAWINGS

FIG. 1 is a block diagram illustrating a hardware configuration of a recognition device according to a first embodiment;

FIG. 2 is a diagram for explaining operations performed using the recognition device according to the first embodiment;

FIG. 3 is a functional block diagram illustrating a configuration of the recognition device according to the first embodiment;

FIG. 4 is a diagram for explaining the tilt in the vertical direction of a specific body part to which a measuring device is attached;

FIG. 5 is a diagram for explaining the tilt in the horizontal direction of the specific body part to which the measuring device is attached;

FIG. 6 is a diagram for explaining the tilt in the clockwise direction and the counterclockwise direction of the specific body part to which the measuring device is attached;

FIG. 7A is a diagram illustrating the acceleration of a wrist in the vertical upward direction when finger snapping is performed;

FIG. 7B is a diagram illustrating the acceleration of a wrist in the vertical upward direction when the hand is swept downward;

FIGS. 8 and 9 are diagrams for explaining giving feedback about an operation state;

FIG. 10 is a flowchart for explaining an overall processing sequence according to the first embodiment;

FIG. 11 is a functional block diagram illustrating a configuration of a recognition device according to a second embodiment;

FIG. 12 is a flowchart for explaining an overall processing sequence according to the second embodiment;

FIG. 13 is a flowchart for explaining a processing sequence that is followed by a determining unit according to the second embodiment;

FIG. 14 is a flowchart for explaining a processing sequence during an operation mode determining operation according to the second embodiment;

FIG. 15 is a diagram for explaining an example in which an operation mode is different for each object;

FIG. 16 is a functional block diagram illustrating a configuration of a recognition device according to a third embodiment;

FIG. 17 is a diagram illustrating an operation image according to the third embodiment;

FIG. 18 is a diagram illustrating an example in which a hand of the user is viewed from above;

FIGS. 19 and 20 are diagrams illustrating operation images according to a fourth embodiment;

FIG. 21 is a diagram for explaining a scroll operation according to the fourth embodiment; and

FIG. 22 is a diagram for explaining an example of implementing the recognition device in a medical information terminal.

### DETAILED DESCRIPTION

According to an embodiment, a recognition device includes an obtaining unit, a selection action recognizing unit, and an output unit. The obtaining unit is configured to obtain a measured value according to an action of a target for measurement. The measured value is measured by a measuring device attached to a specific body part of the target for measurement. The selection action recognizing unit is configured to, based on an acceleration of the specific body part as obtained from the measured value, recognize that a selection action has been performed for selecting any one target for operations included in a screen area. The output unit is configured to, in a state in which the selection action has been performed, output information about an operation state of the target for operations based on an amount of change in a tilt of the specific body part as obtained from the measured value.

### First Embodiment

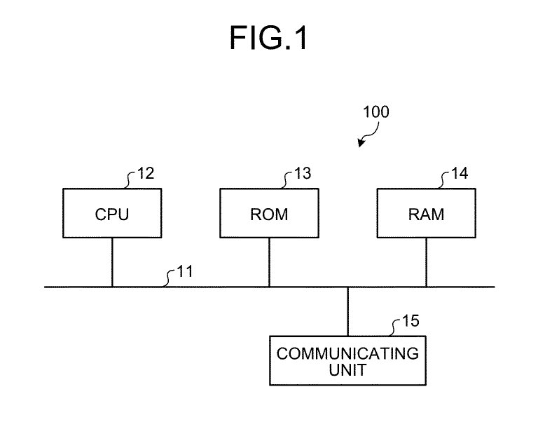

FIG. 1 is a block diagram illustrating an exemplary hardware configuration of a recognition device according to a first embodiment. As illustrated in FIG. 1, a recognition device 100 includes a central processing unit (CPU) 12, a read only memory (ROM) 13, a random access memory (RAM) 14, and a communicating unit 15 that are connected to each other by a bus 11.

Of those constituent elements, the CPU 12 controls the recognition device 100 in entirety. The ROM 13 is used to store computer programs and a variety of data used in the operations performed under the control of the CPU 12. The RAM 14 is used to temporarily store the data used in the operations performed under the control of the CPU 12. The communicating unit 15 communicates with external devices via a network.

The recognition device 100 is implemented in a PC or a television receiver that allows a user to operate a screen by performing gestures representing predetermined actions. For example, the recognition device 100 follows the actions of a hand of the user and moves a pointer placed in a screen area; or magnifies or reduces a target for operations (an object) in the screen area according to the extent of tilt of a hand of the user.

Herein, an action of a hand of the user is recognized based on measured values that are measured by a measuring device which is attached to an arm (a wrist) of the user. The measuring device includes, for example, various sensors used in measuring acceleration, angular velocity, and terrestrial magnetism. Herein, the user serves as the target for measurement, and the measuring device is attached to a specific body part of the target for measurement. Thus, examples of the specific body part include an arm, a wrist, a finger, head, and a leg of the user. In the first embodiment, the explanation is given for an example in which the measuring device is attached to a wrist of the user. That is, the measured values of the measuring device in the form of acceleration or angular velocity can be used as the acceleration or the angular velocity of the hand of the user to which the measuring device is attached.

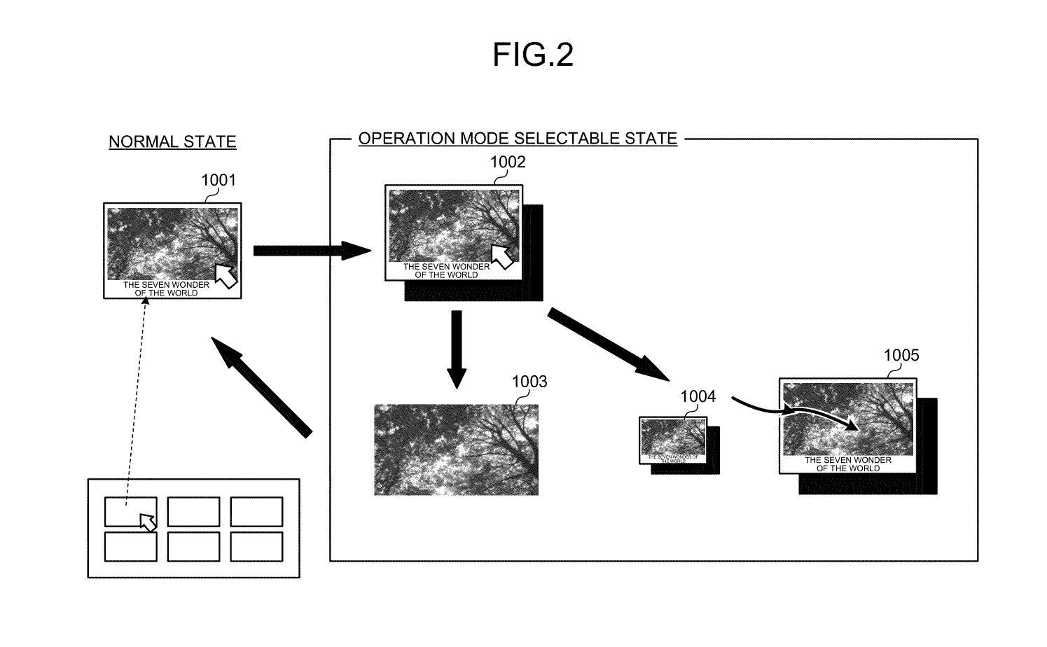

FIG. 2 is a diagram for explaining an example of operations performed using the recognition device 100 according to the first embodiment. With reference to FIG. 2, the explanation is given for an example of selecting an operation mode from the following operation modes: browsing of an object, magnification/reduction of an object, and movement (dragging) of an object. Firstly, as illustrated in the lower left portion in FIG. 2, a pointer placed in a screen area is moved by a user by performing a gesture. In the example illustrated in the lower left portion in FIG. 2, the pointer placed in the screen area is moved to the position of an object placed in the upper left portion of the screen area. Herein, an object 1001 represents the object placed in the upper left portion of the screen area.

Once the pointer is moved on the object 1001, the user performs a gesture such as finger snapping. For example, finger snapping points to a gesture in which the thumb and the middle finger are lightly tapped in a plucking-like manner. The gesture of finger snapping is an example of a selection action for selecting the object that is to be operated from among a plurality of objects. When the user performs a selection action, the selected object is switched to an operation mode selectable state in which an operation mode can be selected as the desired processing with respect to the selected object. Herein, as an object in the operation mode selectable state, an object 1002 is displayed with a shadow in the background. Herein, the shadow in the background represents an example of the information about the operation state, and visually demonstrates the fact that the object is in the operation mode selectable state.

In the operation mode selectable state, the user performs a gesture representing a confirmation action for confirming that an operation is to be performed with respect to the object 1002. With that, the user can browse the object (an object 1003), or can magnify/reduce the object (an object 1004), or can move the object (an object 1005). Switching between such operation modes can be done depending on the elapsed time since the start of the operation mode selectable state until the confirmation action is performed or depending on the amount of change in the tilt of the hand of the user. When an operation mode is changed, then the next change in the operation mode can be done depending on the elapsed time since the previous change in the operation mode until the next confirmation action is performed or depending on the amount of change in the tilt of the hand of the user. Moreover, in the operation mode selectable state, if the confirmation action is not performed for a predetermined amount of time or more, then there occurs transition to the normal state.

For example, if the elapsed time until the confirmation action is performed is smaller than a threshold value, the recognition device 100 switches the selected object to the operation mode for browsing. On the other hand, if the elapsed time until the confirmation action is performed is equal to or greater than the threshold value, then the recognition device 100 magnifies/reduces the selected object or moves the selected object depending on the amount of change in the tilt of the hand. The magnification/reduction of an object or the movement of an object is implemented according to the magnitude relationship between the amount of change in the tilt of the hand and the threshold value. In the first embodiment, regarding the elapsed time, regarding the amount of change in the tilt of the hand, and regarding the relationship with the respective threshold values; the recognition device 100 notifies the user by giving a feedback in the screen area. Such a feedback represents an example of the information about the operation state.

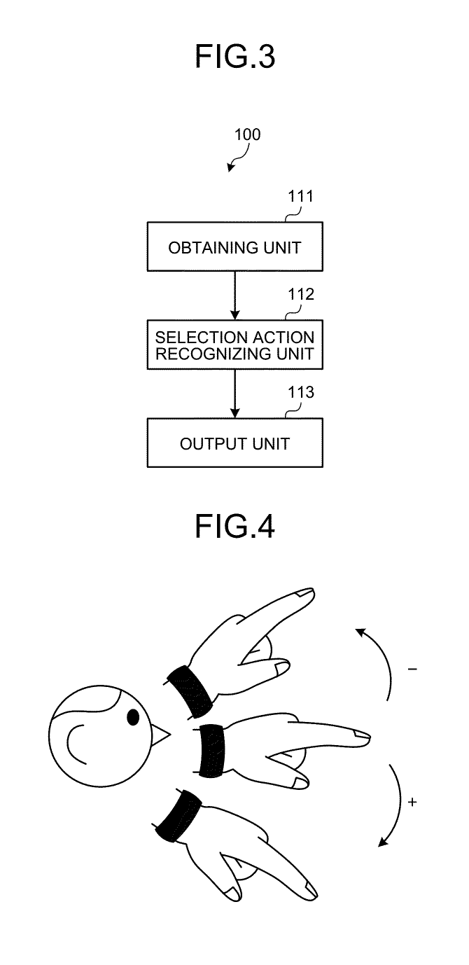

FIG. 3 is a functional block diagram illustrating a configuration example of the recognition device according to the first embodiment. As illustrated in FIG. 3, the recognition device 100 includes an obtaining unit 111, a selection action recognizing unit 112, and an output unit 113. These constituent elements can be partially or entirely implemented using software (computer programs) or using hardware circuitry.

The obtaining unit 111 obtains measured values. More particularly, the obtaining unit 111 obtains measured values that are measured by a measuring device in response to an action performed by the target for measurement. The measuring device includes, for example, various sensors for measuring acceleration, angular velocity, and terrestrial magnetism. The measuring device is attached to a specific body part of the user who serves as the target for measurement. Examples of the specific body part include an arm, a wrist, a finger, head, and a leg of the user. In the first embodiment, the explanation is given for an example in which the measuring device is attached to a wrist of the user. That is, the measured values of the measuring device in the form of acceleration or angular velocity can be used as the acceleration or the angular velocity of the hand of the user to which the measuring device is attached.

The three-dimensional tilt of the hand can be calculated based on the measured values of three-dimensional acceleration, angular velocity, and terrestrial magnetism. Herein, the three dimensions are implemented using the following factors: the pitch representing the angle of rotation in the vertical direction around the horizontal direction of the sensor; the yaw representing the angle of rotation in the horizontal direction around the vertical direction of the sensor; and the roll representing the angle of rotation around the front-back direction of the sensor. These factors differ depending on the position of attachment or the angle of attachment of the measuring device. Hence, for example, if the user attaches the measuring device to an arm like a watch; then the pitch, the yaw, and the roll can be calculated to be equal to the angle of rotation in the vertical direction, the angle of rotation in the horizontal direction, and the angle of clockwise/counterclockwise rotation, respectively, when seen from the user.

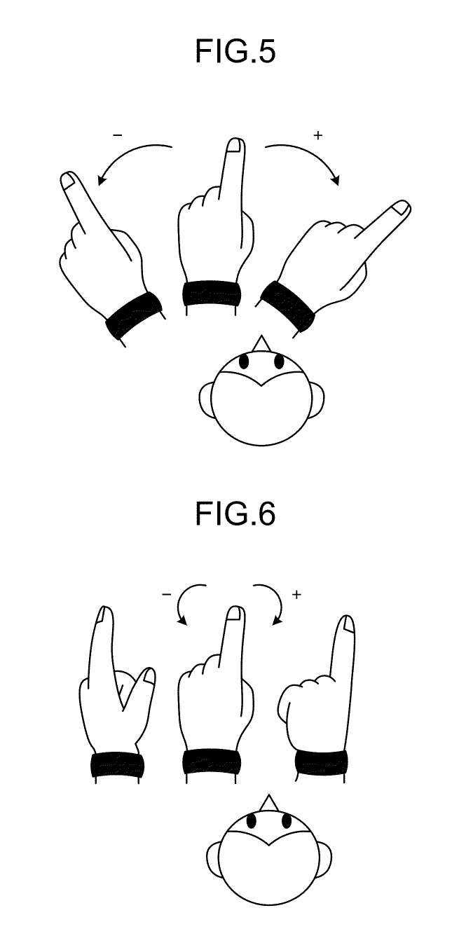

FIG. 4 is a diagram for explaining an example of the tilt in the vertical direction of the specific body part to which the measuring device is attached. For example, as illustrated in FIG. 4, based on the actions of the hand in the vertical direction when seen from the user; with the downward direction (i.e., the direction of “+” illustrated in FIG. 4) assumed to be the positive direction, the relative tilt from the start position of an operation can be calculated in the form of the angle of rotation.

FIG. 5 is a diagram for explaining an example of the tilt in the horizontal direction of the specific body part to which the measuring device is attached. For example, as illustrated in FIG. 5, based on the actions of the hand in the horizontal direction when seen from the user, with the right-hand direction (i.e., the direction of “+” illustrated in FIG. 5) assumed to be the positive direction, the relative tilt from the start position of an operation can be calculated in the form of the angle of rotation.

FIG. 6 is a diagram for explaining an example of the tilt in the clockwise direction and the counterclockwise direction of the specific body part to which the measuring device is attached. For example, as illustrated in FIG. 6, based on the actions of the hand in the clockwise direction and the counterclockwise direction when seen from the user; with the clockwise direction (i.e., the direction of “+” illustrated in FIG. 6) assumed to be the positive direction, the relative tilt from the start position of the operations can be calculated as the angle of rotation.

The selection action recognizing unit 112 recognizes, based on the acceleration of the specific body part, that a selection action is performed for selecting one of the targets for operations included in the screen area. More particularly, from the acceleration of the specific body part as obtained from the measured values obtained by the obtaining unit 111; the selection action recognizing unit 112 recognizes that the user has performed a gesture such as finger snapping, that is, recognizes that the user has performed a selection action. As far as whether or not a selection action is performed, it is possible to do the determination depending on whether or not the temporal changes in the acceleration or the amount of change in the acceleration satisfy a particular condition. For example, if the magnitude of the acceleration becomes equal to or greater than a threshold value or if the amount of change in the acceleration per hour becomes equal to or greater than a threshold value, then the selection action recognizing unit 112 recognizes that a selection action is performed.

Regarding the acceleration, although it is possible to obtain the values in each of the three axial directions, the gesture of finger snapping can be determined using the values of a particular axis. For example, of the acceleration obtained from the sensor that is attached to a wrist of the user, it is possible to make use of the acceleration in the vertical upward direction with respect to the arm when the gesture illustrated in FIG. 5 is performed.

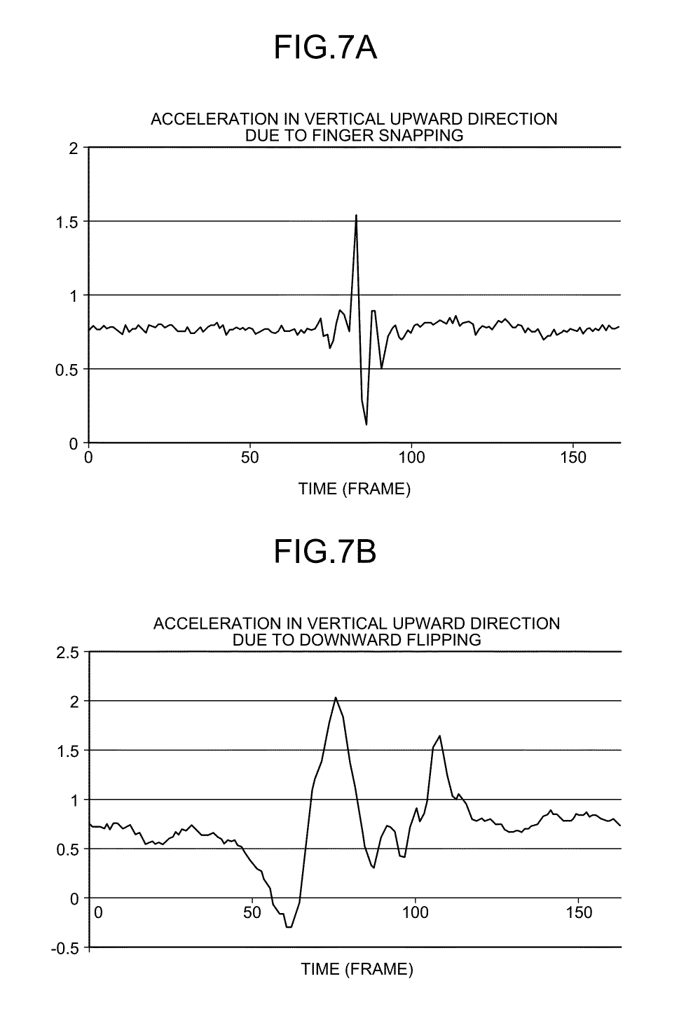

FIG. 7A is a diagram illustrating an example of the acceleration of a wrist in the vertical upward direction when the gesture of finger snapping is performed. FIG. 7B is a diagram illustrating an example of the acceleration of a wrist in the vertical upward direction when the gesture of sweeping the hand downward (flipping the hand downward) is performed. As illustrated in FIGS. 7A and 7B, as compared to the gesture of sweeping the hand downward, it can be seen that the gesture of finger snapping has a shorter period of time in which the waveform of acceleration is detected as well as has a steeper shape.

There, from a first condition and a second condition explained below, the fact that a selection action is performed can be recognized. The first condition points to a condition in which, with the average value of acceleration in a predetermined period of time in the past serving as the reference value, the amount of change in the acceleration is equal to or greater than a predetermined threshold A1. The second condition points to a condition in which, while Tmax represents the timing of maximum amount of change in the acceleration in comparison to the reference value and while T1 and T2 represent predetermined time intervals, the amount of change in the acceleration from a timing Tmax−T2 to a timing Tmax−T1 as well as the amount of change in the acceleration from a timing Tmax+T1 to a timing Tmax+T2 is smaller than a predetermined threshold value A2. Herein, the time intervals T1 and T2 satisfy the relationship of T2>T1. Moreover, the predetermined threshold values A1 and A2 satisfy the relationship of A1>A2. For example, as long as the predetermined threshold value A2 is a value equal to about half of the predetermined threshold value A1 or equal to or smaller than half of the predetermined threshold A1, it serves the purpose. Moreover, the predetermined threshold value A2 is greater than the reference value. Furthermore, the predetermined period of time in the past is, for example, about 100 milliseconds (ms) to 300 ms. If the average value of acceleration over quite a long period of time is set as the reference value, then there is a chance that repetition in the gesture of finger snapping is difficult to detect. Hence, it serves the purpose if the reference value is suitably changed according to the user specifications. Meanwhile, the threshold value Alcan be defined as, for example, “0.5×acceleration due to gravity”, or can be determined based on the peak value after performing a finger snapping action at the time of initial setting.

More specifically, the timer interval from the timing Tmax−T2 to the timing Tmax−T1 and the time interval from the timing Tmax+T1 to the timing Tmax+T2 are time intervals around the timing Tmax at which the maximum amount of change occurs. As described above, the waveform of the gesture of finger snapping has a short period of time in which the waveform of acceleration is detected as well as has a steep shape. For that reason, around the timing at which the maximum amount of change occurs in the acceleration; if the waveform has an equivalent value to the reference value, then it can be recognized that a gesture of finger snapping is performed. By adopting the first condition and the second condition, it becomes possible to prevent a situation in which a gesture other than finger snapping, such as a gesture of sweeping the hand downward as illustrated in FIG. 7B, is recognized as a selection action.

Meanwhile, it is also possible to apply a third condition in addition to the first condition and the second addition. The third condition points to a condition in which, in the time interval around the timing Tmax, a stationary state is observed in which the positions of the wrist are within a predetermined range. If the positions of the wrist can be calculated in chronological order, then applying the third condition while performing the determination makes it possible to recognize, with a high degree of accuracy, the fact that a selection action is performed. Meanwhile, the gesture representing a selection action is not limited to finger snapping. Alternatively, for example, an arbitrary gesture such as holding (griping) a hand, shaking downward the portion of a hand from the wrist to the fingers, pushing out a palm forward, or cracking fingers.

The output unit 113 outputs the information about the operation state of the target for operations. More particularly, in the state in which a selection action has been performed, the output unit 113 outputs the information about the operation state of the target for operations based on the elapsed time since the selection action and the amount of change in the tilt of the specific body part. Herein, outputting the information about the operation state implies giving a feedback about the present operation state in the screen area. Herein, the operation state points to, for example, the information indicating whether or not an object is in the operation mode selectable state or the information indicating the operation mode in the operation mode selectable state.

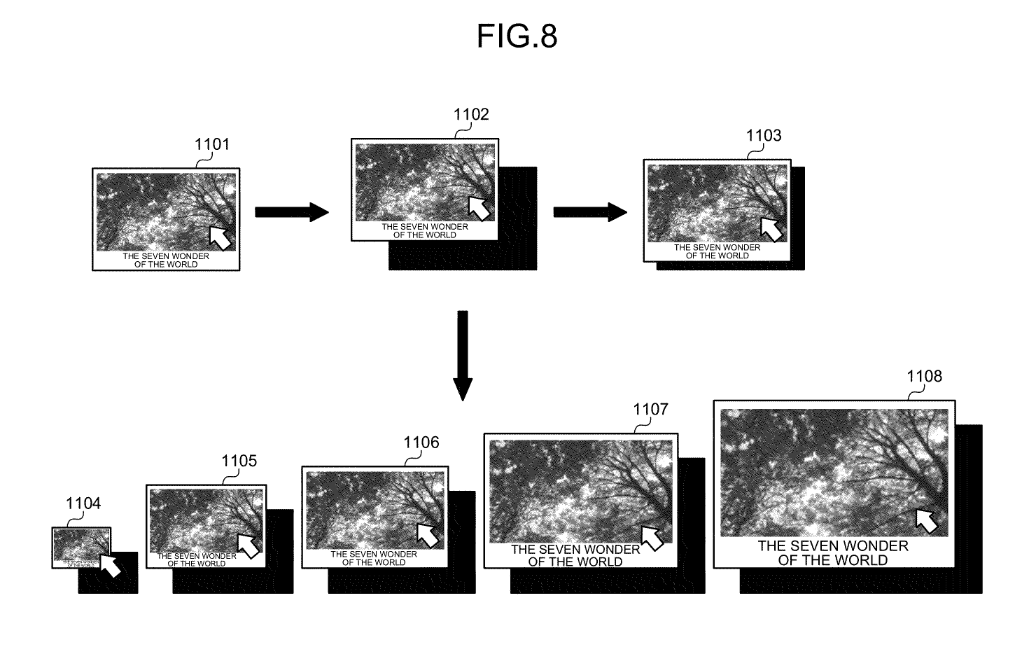

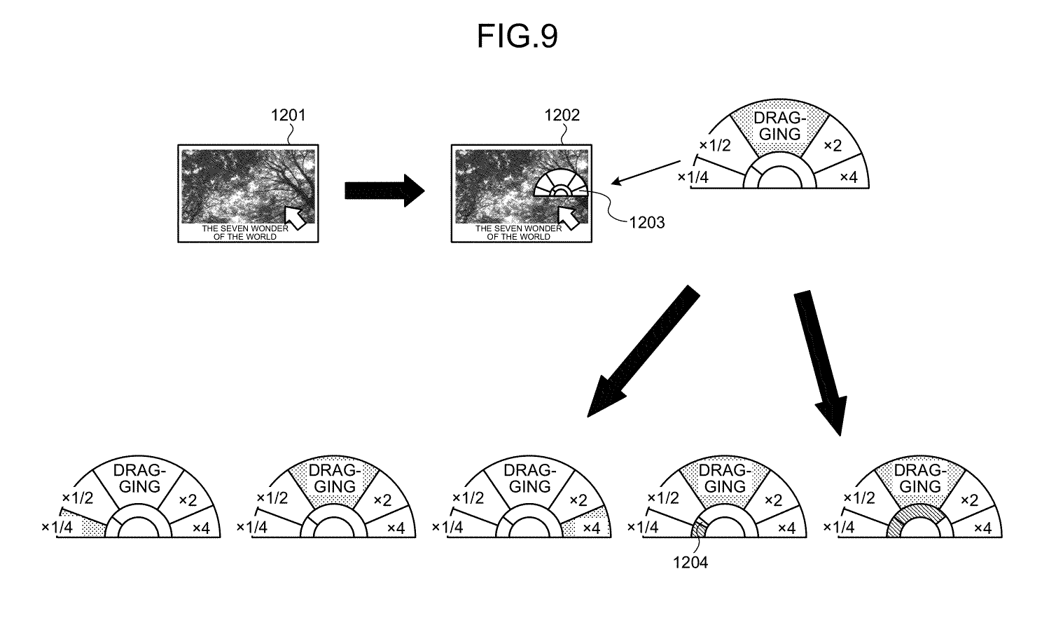

FIGS. 8 and 9 are diagrams for explaining giving feedback about the operation state. As illustrated in FIG. 8, when a selection action is performed with respect to an object 1101 in the normal state, then a shadow appears in the background of an object 1102 thereby giving the object 1102 a floating appearance. This state indicates that the object 1102 is in the operation mode selectable state. Alternatively, whether or not an object is in the operation mode selectable state can be indicated using an animation is which the object appears to be shaking. With such appearances, it becomes possible to create an impression on the user that, unlike the object 1101, the object 1102 is not a fixed object and is free of restrictions.

Meanwhile, as is the case of an object 1103, the shadow in the background can be gradually reduced over time from the state of the object 1102. As described earlier, in the operation mode selectable state, if the confirmation action is not performed for a predetermined period of time or beyond, then the selected object is switched to the normal state. In that regard, if the shadow in the background is gradually reduced over time, it becomes possible to make the user understand the timing of transition to the normal state. Thus, as is the case of the object 1103, by performing interpolation to ensure that the shadow in the background disappears over time, the elapse in time is expressed in a relative manner. Meanwhile, in the state in which the shadow in the background is being displayed, if the user performs some gesture, then the display can be reverted to displaying the background shadow for transition to the operation mode selectable state. Moreover, if it is detected that the user has performed a cancel operation, the operation mode selectable state can be forcibly terminated followed by switching the selected object to the normal state; and the display of the shadow in the background of that object can be erased.

Meanwhile, as illustrated in FIG. 8, with respect to the object 1102 in the operation mode selectable state, if a gesture for magnification or reduction is performed, then the object 1102 is switched to the states of objects 1104 to 1108. The magnification or reduction of an object is implemented when a feedback of the amount of change in the tilt of the hand is given as the scaling factor of magnification or reduction. For example, as illustrated in FIG. 6, if the hand is twisted in the “+” direction, then the object is magnified according to the change in the hand position. Similarly, if the hand is twisted in the “−” direction, then the object is reduced according to the change in the hand position.

Aside from that, the configuration can be such that, when a predetermined threshold angle is exceeded, magnification or reduction is performed only by a set scaling factor. For example, assume that φ represents the amount of change in the tilt of the hand from the time of switching an object to the operation mode selectable state. Then, if the amount of change φ in the tilt of the hand satisfies −30°≦φ<30°, then it is ensured that the scaling factor is not changed (see the object 1105). However, if the amount of change φ in the tilt of the hand satisfies −60°φ<−45°, then the scaling factor is set to one-fourth (see the object 1104). Moreover, if the amount of change φ in the tilt of the hand satisfies 30°≦φ<45°, then the scaling factor is set to two (see the object 1107). Furthermore, if the amount of change φ in the tilt of the hand satisfies 45°≦φ<60°, then the scaling factor is set to four (see the object 1108).

Meanwhile, in order to give feedback about the operation state, it is also possible to use an indicator. As illustrated in FIG. 9, if a selection action is performed with respect to an object 1201 in the normal state, an indicator 1203 is displayed at an arbitrary position on the object 1201. In the indicator 1203, on the outside of a semicircular shape, operations according to the tilt of the hand are displayed; while on the inside of the semicircular shape, operations corresponding to the time are displayed. For example, on the outside of the semicircular shape, depending on the amount of change in the tilt of the hand, the scaling factor for magnifying or reducing an object 1202 is displayed. In addition, on the outside of the semicircular shape, when the scaling factor of the object 1202 is one, then information indicating a possibility of dragging is displayed. Meanwhile, regarding giving feedback about the amount of change in the tilt of the hand, a threshold value can be arbitrarily displayed along with information indicating the present operation mode.

On the inside of the semicircular shape, information about the elapsed time is given as feedback. Herein, as the information about the elapsed time, a threshold time 1204 is displayed. That is, if the confirmation action is performed before the threshold time 1204 is reached, then the object 1202 is switched to a browsing mode (using full-screen display or the like). However, if the confirmation action is performed after the threshold time 1204 has passed, then the object 1202 is switched to a mode for magnification/reduction or dragging. When the semicircle gets filled with the elapsed time, the object 1202 is switched to the normal state.

Meanwhile, as far as giving feedback of the information about the operation state is concerned, it is not limited to the explanation given above. Alternatively, for example, when there is a change in the operation mode, feedback can be given by controlling the measuring device attached to the specific body part to output sound, electrical signals, or vibrations. Still alternatively, feedback can be given by communicating via arbitrary wireless communication and instructing an external device to output voice or light.

Moreover, the gesture for implementing each function is not limited to the explanation given above. For example, when the relative change in the depth direction of the hand can be estimated from the amount of change in the tilt of the hand, an object can be magnified/reduced according to the relative change in the depth direction of the hand or an object can be rotated according to the twist of the hand. In the case of using the depth direction of the hand, the scaling factor can be varied according to the relationship between the tilt corresponding to the depth direction of the hand and a threshold value. Similarly, the degree of rotation can be varied according to the relationship between the tilt corresponding to the twist of the hand and a threshold value.

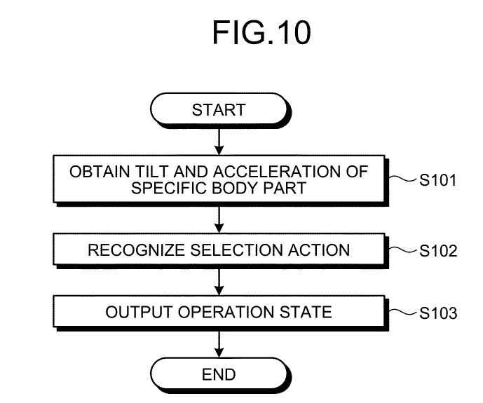

Explained below with reference to FIG. 10 is an overall processing sequence according to the first embodiment. FIG. 10 is a flowchart for explaining an example of the overall processing sequence according to the first embodiment.

As illustrated in FIG. 10, the obtaining unit 111 includes various sensors and obtains the tilt and the acceleration of a specific body part of a user as measured by a measuring device that is attached to the specific body part (Step S101). Then, by referring to the acceleration of the specific body part as obtained by the obtaining unit 111, the selection action recognizing unit 112 recognizes that a selection action is performed (Step S102). In the state in which a selection action has been performed, the output unit 113 outputs the information about the operation state of the target for operations based on the elapsed time since the selection action and the amount of change in the tilt of the specific body part (Step S103).

In the first embodiment, based on the measured values that are measured by the measuring device which is attached to the specific body part of the user, it is recognized that a selection action is performed for selecting the target for operations within the screen area. Moreover, based on the amount of change in the tilt of the specific body part, the information about the operation state of the target for operations is output. Thus, according to the first embodiment, it is not necessary to display the menu screen every time some sort of processing is performed. Hence, it becomes possible to enhance the operability at the time of performing processing corresponding to the recognized action.

### Second Embodiment

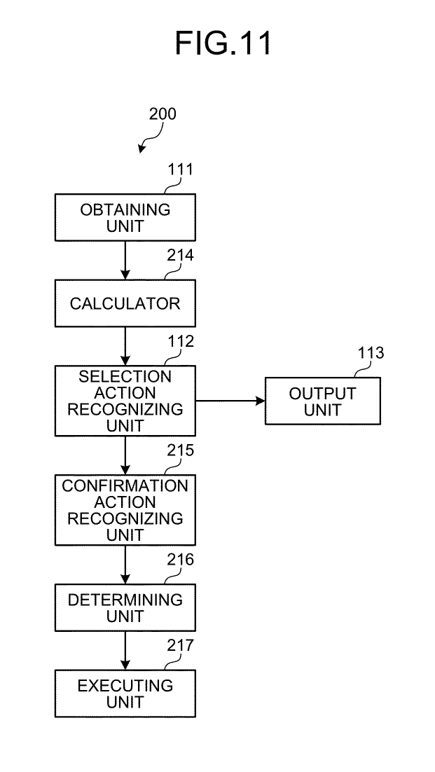

FIG. 11 is a functional block diagram illustrating a configuration example of a recognition device according to a second embodiment. In the second embodiment, the constituent elements identical to the first embodiment are referred to by the same reference numerals, and the detailed explanation of such constituent elements is sometimes not repeated. In the second embodiment, the obtaining unit 111, the selection action recognizing unit 112, and the output unit 113 have the same functions, configurations, and operations as described in the first embodiment.

As illustrated in FIG. 11, a recognition device 200 includes the obtaining unit 111, the selection action recognizing unit 112, the output unit 113, a calculator 214, a confirmation action recognizing unit 215, a determining unit 216, and an executing unit 217.

The calculator 214 calculates a pointed position in the screen area. Herein, the pointed position points to the position of an instruction image of a pointer. More particularly, based on the tilt of the specific body part obtained from the measured values that are obtained by the obtaining unit 111, the calculator 214 calculates the position of the pointer included in the screen area. For example, regarding each tilt of the specific body part, it is assumed that α represents the rotational angle pitch in the vertical direction, β represents the rotational angle yaw in the vertical direction, and γ represents the rotational angle roll around the front-back direction.

Firstly, a predetermined reference point in the screen area is set in advance in a corresponding manner to a predetermined tilt of the specific body part. For example, a tilt (α_{c}, β_{c}, γ_{c}) of the specific body part at the start of an operation is set to correspond to a predetermined position, such as a center (X_{c}, Y_{c}), in the screen area. Meanwhile, in order to simplify the processing, only the tilt β in the horizontal direction and the tilt α in the vertical direction can be used; and the tilt β can be converted to represent the changes in the x-axis on the screen area and the tilt α can be converted to represent the changes in the y-axis on the screen area. At that time, if the tilt of the specific body part is (β_{c}, αₛ), then the point (X_{c}, Y_{c}) in the screen area corresponds to the tilt.

Moreover, a predetermined distance in the screen area is set to be corresponding to a predetermined amount of change in the tilt of the hand. For example, the settings are done in such a way that the amount of change equivalent to 40° of the rotational angle yaw β in the horizontal direction is set to be equal to a lateral size Lₓ, and the amount of change equivalent to 40° of the rotational angle pitch α in the vertical direction is set to be equal to a longitudinal size L. With that, with respect to the tilt (β, α) of the specific body part, a position (X, Y) in the screen area can be calculated by performing linear interpolation using equations given below.

X=X_{c}+Lₓ(β−β_{c})/40

Y=Y_{c}+L_{y}(α−α_{c})/40

As a result of setting each parameter by taking into account the distance between the user who is wearing the measuring device and the screen area and by taking into account the range within which the hand of the user can move; if the user points to the screen area from afar using the hand to which the measuring device is attached, the pointer can be placed at a position that is an extension of the pointing direction. Hence, the user can have the feeling of being able to do the pointing from afar.

In the screen area, 0≦X≦Lₓ and 0≦Y≦L_{y} are satisfied. However, if the position (X, Y) is not included in the screen area, then the pointer can be considered to be positioned outside the screen area and may not be displayed. Alternatively, even if the position (X, Y) is not included in the screen area, with the aim of retaining the position of the specific body part on the fringe of the screen area, the tilt of the specific body part corresponding to the center of the screen area can be updated to (α_{c}′, β_{c}′, γ_{c}′). If it is possible to retain the position of the specific body part in the screen area; then, regardless of the position of the hand of the user, pointing can be done without losing sight of the pointer.

The selection action recognizing unit 112 recognizes that a selection action has been performed for selecting an object corresponding to the position of the pointer calculated by the calculator 214.

The confirmation action recognizing unit 215 recognizes that a confirmation action has been performed for confirming that an operation is to be performed with respect to the target for operations. More particularly, after the selection action recognizing unit 112 recognizes a selection action, the confirmation action recognizing unit 215 recognizes that a confirmation action in the form of a gesture is performed for confirming that ab operation is to be performed with respect to the selected target for operations. Herein, the confirmation action can be in the form of an arbitrary gesture, which may be same as the gesture representing the confirmation action described above. Meanwhile, it is also possible that, after the elapse of a predetermined period of time since the selection action, it can be considered that a confirmation action is performed.

The determining unit 216 determines the operation mode. More particularly, in the state in which the confirmation action recognizing unit 215 recognizes that a confirmation action has been performed, the determining unit 216 determines the operation mode based on the amount of change in the tilt of the specific body part and based on the elapsed time. The details about the processing performed by the determining unit 216 are given later.

The executing unit 217 performs processing according to the operation mode that has been determined. More particularly, with respect to the target for operations corresponding to the position of the pointer, the executing unit 217 performs processing according to the operation mode determined by the determining unit 216. For example, if the operation mode indicates browsing of an object, then the determining unit 216 displays that object in a magnified manner in a specified window or using full-screen display.

Alternatively, if the operation mode indicates magnification/reduction of an object, then the determining unit 216 magnifies or reduces that object with the scaling factor calculated according to the tilt of the hand. At that time, magnification or reduction can be done around the middle portion of the object. Moreover, along with the magnification of the object, the detailed information of that object can also be displayed. If a plurality of objects is arranged in the screen area, then magnification of the concerned object can be accompanied by reducing the other objects in such a way that all objects fit in the screen area.

Still alternatively, if the operation mode indicates dragging an object, then the determining unit 216 drags that object along with the movement of the pointer. Regarding dragging of an object, when it is recognized that a confirmation action is performed, the object can be moved to the position of the pointer. At that time, as far as moving the object is concerned, it can be moved instantaneously to the destination or can be moved little by little in a linear manner as a movement animation. Alternatively, as far as moving the object is concerned, it can be moved in alignment with the pointer until a confirmation action is recognized.

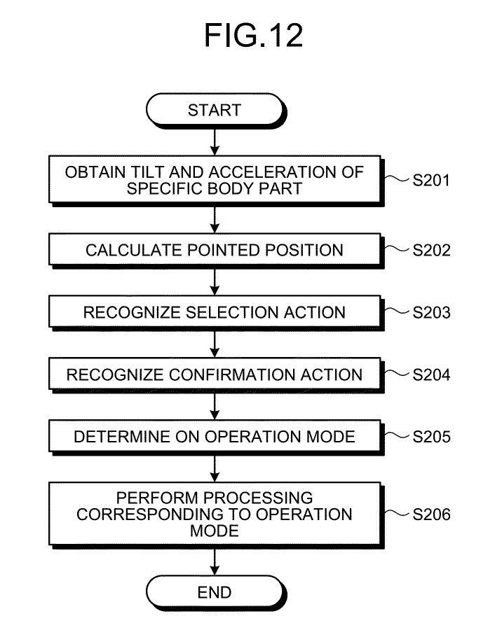

Explained below with reference to FIG. 12 is an overall processing sequence according to the second embodiment. FIG. 12 is a flowchart for explaining an example of the overall processing sequence according to the second embodiment. Herein, although not illustrated in FIG. 12, the output unit 113 arbitrarily outputs the information about the operation state.

As illustrated in FIG. 12, the obtaining unit 111 includes various sensors and obtains the tilt and the acceleration of a specific body part of a user as measured by a measuring device that is attached to the specific body part (Step S201). Then, based on the tilt of the specific body part as obtained by the obtaining unit 111, the calculator 214 calculates the position of the pointer within the screen area (Step S202). Moreover, from the acceleration of the specific body part as obtained by the obtaining unit 111, the selection action recognizing unit 112 recognizes that a selection action has been performed with respect to the target for operations which corresponds to the position of the pointer calculated by the calculator 214 (Step S203).

In the state in which the selection action has been recognized by the selection action recognizing unit 112, the confirmation action recognizing unit 215 recognizes that a confirmation action has been performed for confirming that an operation is to be performed with respect to the selected target for operations (Step S204). Then, in the state in which the confirmation action has been recognized by the confirmation action recognizing unit 215, the determining unit 216 determines the operation mode based on the amount of change in the tilt of the specific body part and based on the elapse of the time (Step S205). The executing unit 217 performs processing according to the operation mode determined by the determining unit 216 (Step S206).

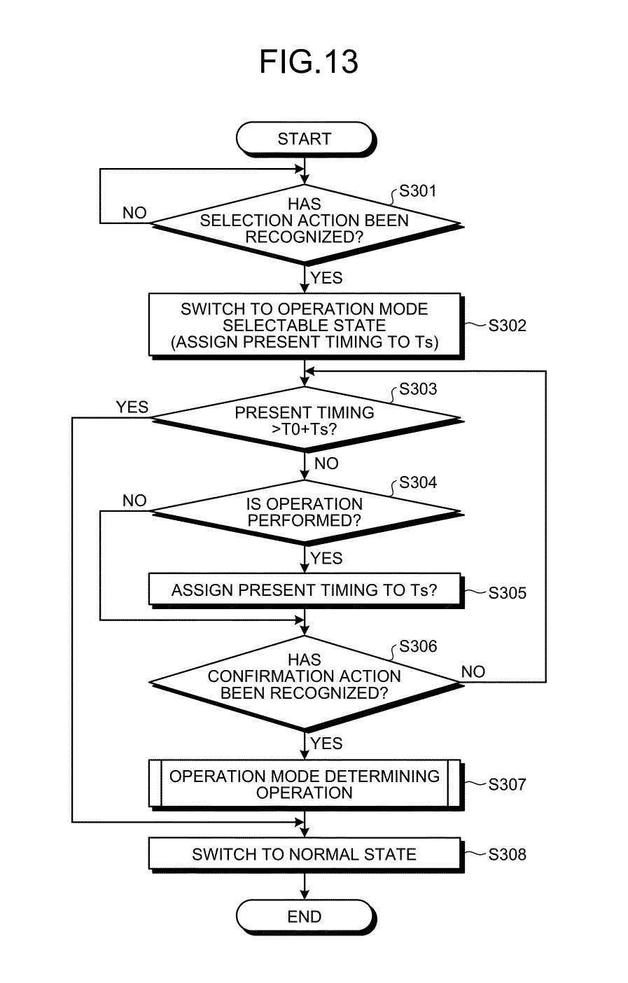

Explained below with reference to FIG. 13 is the processing performed by the determining unit 216 according to the second embodiment. FIG. 13 is a flowchart for explaining an exemplary processing sequence that is followed by the determining unit 216 according to the second embodiment.

As illustrated in FIG. 13, when the selection action recognizing unit 112 recognizes that a selection action is performed (Yes at Step S301), the selected object is switched to the operation mode selectable state and the determining unit 216 registers that timing as Ts (Step S302). On the other hand, if the selection action recognizing unit 112 does not recognize that a selection action is performed (No at Step S301); it waits for a selection action to be performed.

Herein, it is assumed that T0 represents a predetermined amount of time. The determining unit 216 determines whether or not the present timing is greater than T0+Ts (Step S303). That is, the determining unit 216 determines whether or not the timing of switching the object to the operation mode selectable state, that is, the timing Ts at which the user last performed an operation has passed the predetermined amount of time T0. If the determining unit 216 determines that the present timing is greater than T0+Ts (Yes at Step S303), then the object is switched to the normal state (Step S308). That is, since the user did not perform an operation even after the elapse of the predetermined amount of time T0, the display returns to displaying the selected object in the normal state.

However, if the present timing is determined to be smaller than T0+Ts (No at Step S303), then the determining unit 216 determines whether or not the user has performed an operation (Step S304). Herein, examples of the operation include changing the operation mode, dragging an object, and the like. If the user has performed an operation (Yes at Step S304), the determining unit 216 records the present timing as Ts (Step S305). That is, since the user has performed some sort of operation, the elapse of the predetermined amount of time T0 from the present timing is determined again. On the other hand, if the user has not performed an operation (No at Step S304); then the system control proceeds to Step S306.

Then, the determining unit 216 determines whether or not the confirmation action recognizing unit 215 has recognized that a confirmation action has been performed (Step S306). If it is recognized that a confirmation action has been performed (Yes at Step S306), then the determining unit 216 performs an operation mode determining operation (Step S307). After the operation mode determining operation is performed, the concerned object is switched to the normal state (Step S308). The explanation about the operation mode determining operation is given later. Meanwhile, if it is not recognized that a confirmation action has been performed (No at Step S306), then the operation at Step S303 is performed again. That is, with no recognition of a confirmation action, if the user does not perform an operation even after the elapse of the predetermined amount of time T0, then the display returns to displaying the selected object in the normal state.

Herein, the explanation above is given about switching to the normal state after the elapse of the predetermined amount of time T0. However, alternatively, it is possible to switch to the normal state based on the gesture for cancelling the operation.

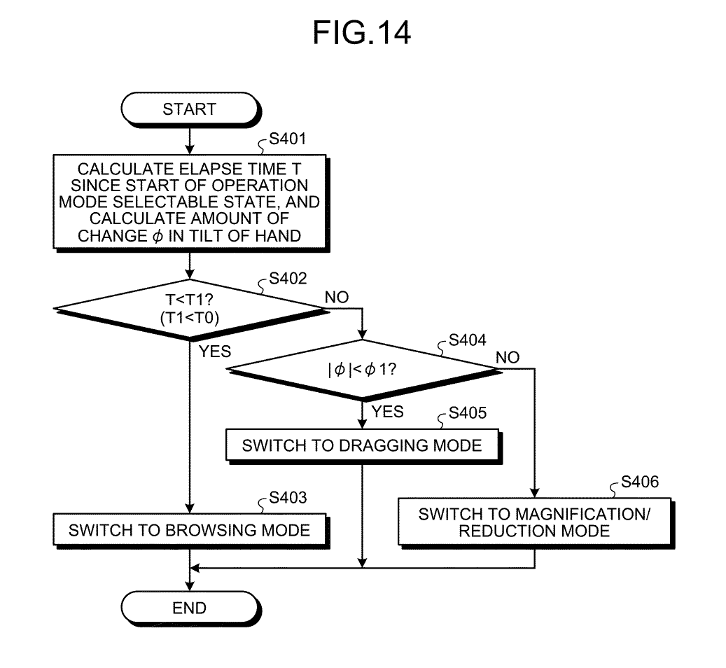

FIG. 14 is a flowchart for explaining an exemplary processing sequence during the operation mode determining operation according to the second embodiment. With reference to FIG. 14, depending on the magnitude relationship between an elapsed time T since the start of the operation mode selectable state and a threshold value as well as depending on the an amount of change φ in the tilt of the hand since the start of the operation mode selectable state and a threshold value, an operation mode is determined that corresponds to the processing with respect to the selected object. Herein, the operation mode can be any one of the following: a browsing mode for browsing an object; a dragging mode for dragging an object; and a magnification/reduction mode for magnifying or reducing an object.

As illustrated in FIG. 14, the determining unit 216 calculates the elapsed time T starting from the recognition of the selection action by the selection action recognizing unit 112 to the recognition of the confirmation action by the confirmation action recognizing unit 215 (Step S401). Moreover, the determining unit 216 calculates the amount of change φ in the tilt of the hand starting from the recognition of the selection action by the selection action recognizing unit 112 to the recognition of the confirmation action by the confirmation action recognizing unit 215 (Step S401). Herein, the amount of change φ in the tilt of the hand is obtained from the measured values obtained by the obtaining unit 111.

Then, the determining unit 216 determines whether or not T<T1 is satisfied with respect to a predetermined threshold value T1 (T1<T0) (Step S402). That is, the determining unit 216 determines whether or not the confirmation action is performed immediately after the selection action. If T<T1 is satisfied (Yes at Step S402), then the determining unit 216 determines to switch the concerned object to the browsing mode (Step S403). On the other hand, if T<T1 is not satisfied (No at Step S402), then the determining unit 216 determines whether or not |φ|<φ1 is satisfied (Step S404). Herein, φ1 represents a predetermined angle, and is compared with the absolute value of the amount of change φ of the tilt of the hand. Thus, at Step S404 illustrated in FIG. 9, it is determined that, when the absolute value of the amount of change φ of the tilt of the hand is smaller than the predetermined angle φ1, the operation mode is set to the dragging mode; and, when the absolute value of the amount of change φ of the tilt of the hand is greater than the predetermined angle φ1, the operation mode is set to the magnification/reduction mode.

If |φ|<φ1 is satisfied (Yes at Step S404), then the determining unit 216 determines to switch the concerned object to the dragging mode (Step S405). On the other hand, when |φ|<φ1 is not satisfied (No at Step S404), the determining unit 216 determines to switch the concerned object to the magnification/reduction mode (Step S406). As far as the scaling factor for magnification or reduction is concerned, it can be changed according to the amount of change φ of the tilt of the hand. For example, with φ1 set to 30°, when −45°≦φ≦−30° is satisfied, the scaling factor can be set to half. Alternatively, when −60°≦φ<−45° is satisfied, the scaling factor can be set to one-fourth. Still alternatively, when 30°≦φ<45° is satisfied, the scaling factor can be set to two. Still alternatively, when 45°≦φ<60° is satisfied, the scaling factor can be set to four.

As a result, for example, when a gesture such as finger snapping is performed in a short interval of time such as double-clicking, it is made possible to browse the object. In an identical manner, when a gesture such as finger snapping is followed by a movement of the hand, it is made possible to drag an object. Similarly, when a gesture such as finger snapping is followed by twisting of the hand, it is made possible to magnify or reduce an object.

The explanation given above is for an example in which the operation mode determining operation is performed after the confirmation action is performed. However, alternatively, in the second embodiment, every time before the recognition of a confirmation action, the operation mode determining operation can be performed. For example, in the operation mode determining operation (at Step S307) illustrated in FIG. 13, assume that T represents the elapsed time from the start of the operation mode selectable state to the present point of time and φ represents the amount of change in the tilt of the hand from the start of the operation mode selectable state to the present point of time. Then, the operation mode determining operation is performed before the operation performed at Step S306. As a result, even in the state in which a confirmation action is not recognized, it becomes possible to switch between the operation modes.

For example, after a selection action is recognized, if the hand is moved without twisting and is then twisted at the post-movement stationary position; then it becomes possible to perform an operation of magnifying or reducing an object while dragging it. Subsequently, when a confirmation action is recognized, these operations can be confirmed as a plurality of operation modes. Moreover, with the aim of giving feedback of the operation state, the display can also be changed every time. For example, during a dragging action, the object can be moved and can be magnified or reduced with the scaling factor according to the twist of the hand. Moreover, while moving the hand for the purpose of dragging an object, the setting can be such that magnification or reduction does not occur even if the hand is twisted. Meanwhile, the operation modes are not limited to the modes given above.

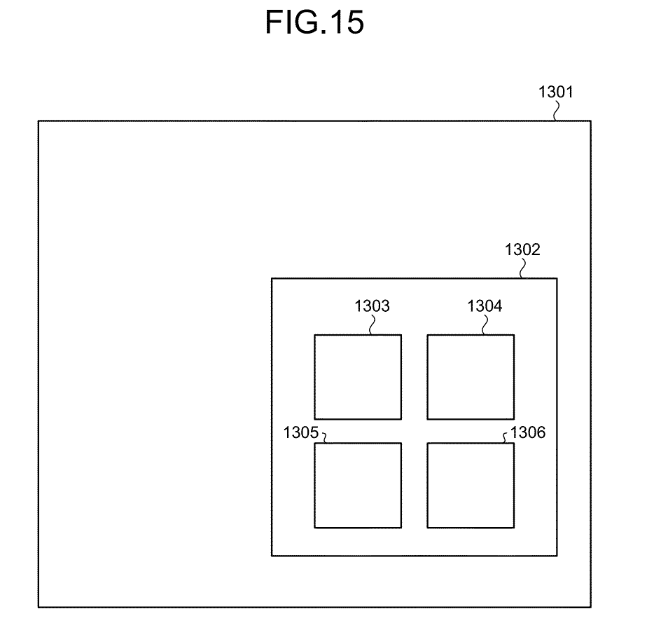

Moreover, the selectable operation modes can be changed depending on the type of the object specified during a selection action. FIG. 15 is a diagram for explaining an example in which the operation mode is different for each object. As illustrated in FIG. 15, the explanation is given for an example in which a window 1302 is displayed in a screen area 1301, and objects 1303 to 1306 are arranged in the window 1302. For example, if a selection action is recognized in a state in which the pointer is placed on the objects 1303 to 1306, then the operation modes described above are applicable. However, if a selection action is recognized in a state in which the pointer is placed on the window 1302, then magnification or reduction according to the tilt of the hand can be replaced with rotation according to the tilt of the hand. Alternatively, the configuration can be such that rotation according to the tilt of the hand is performed with respect to each object arranged in the window 1302.

According to the second embodiment, the operation mode is determined based on the amount of change in the tilt of the specific body part. Then, with respect to the object corresponding to the position of a pointer, the processing is performed according to the determined operation mode. Hence, it becomes possible to enhance the operability at the time of performing processing corresponding to the recognized action.

### Third Embodiment

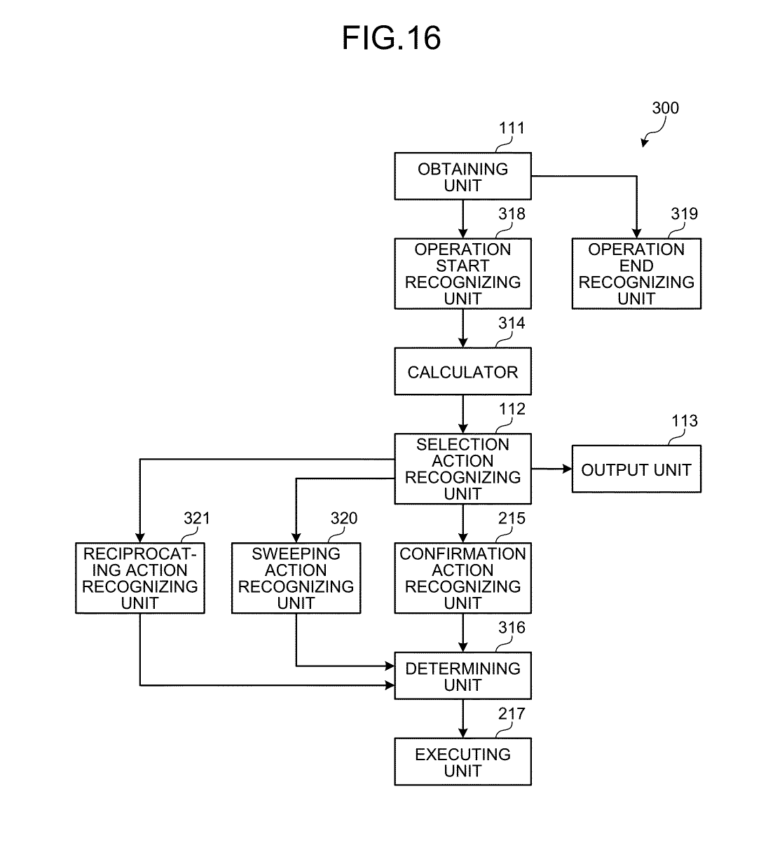

FIG. 16 is a functional block diagram illustrating a configuration example of a recognition device according to a third embodiment. In the third embodiment, the constituent elements identical to the first embodiment and the second embodiment are referred to by the same reference numerals, and the detailed explanation of such constituent elements is sometimes not repeated. In the third embodiment, except for a calculator 314, a determining unit 316, an operation start recognizing unit 318, an operation end recognizing unit 319, a sweeping action recognizing unit 320, and a reciprocating action recognizing unit 321; the constituent elements have the same functions, configurations, and operations as described in the first embodiment and the second embodiment.

As illustrated in FIG. 16, a recognition device 300 includes the obtaining unit 111, the selection action recognizing unit 112, the output unit 113, the calculator 314, the confirmation action recognizing unit 215, the determining unit 316, and the executing unit 217. In addition, the recognition device 300 includes the operation start recognizing unit 318, the operation end recognizing unit 319, the sweeping action recognizing unit 320, and the reciprocating action recognizing unit 321.

The operation start recognizing unit 318 recognizes that a start action has been performed for starting the operation with respect to the target for operations. More particularly, based on the tilt of the specific body part obtained from the measured values that are obtained by the obtaining unit 111, the operation start recognizing unit 318 recognizes that a start action has been performed for starting the operation with respect to an object.

The operation end recognizing unit 319 recognizes that an end action has been performed for ending the operation with respect to the target for operations. More particularly, based on the tilt of the specific body part obtained from the measured values that are obtained by the obtaining unit 111, the operation end recognizing unit 319 recognizes that an end action has been performed for ending the operation with respect to an object. When the operation end recognizing unit 319 recognizes an end action, the concerned object is switched to the normal state and a non-operation mode is set indicating that no operation mode is determined.

The processing performed by the calculator 314 onward is performed in response to the recognition of a start action by the operation start recognizing unit 318. That is, during the period of time since the recognition of a start action to the recognition of an end action, the calculator 314 performs processing to calculate the position of the pointer.

The sweeping action recognizing unit 320 recognizes that a sweeping action has been performed for sweeping the specific body part. More particularly, in the state in which the selection action recognizing unit 112 has recognized that a selection action has been performed; the sweeping action recognizing unit 320 recognizes, based on at least either the temporal changes in the position of the pointer as calculated by the calculator 314 or the amount of change in the tilt of the specific body part, that a sweeping action has been performed for sweeping the specific body part.

The reciprocating action recognizing unit 321 recognizes that a reciprocating action has been performed for moving the specific body part back and forth. More particularly, in the state in which the selection action recognizing unit 112 has recognized that a selection action has been performed; the reciprocating action recognizing unit 321 recognizes, based on at least either the temporal changes in the position of the pointer as calculated by the calculator 314 or the amount of change in the tilt of the specific body part, that a reciprocating action has been performed for moving the specific body part back and forth.

Thus, at least either based on whether or not the sweeping action recognizing unit 320 has recognized a sweeping action or based on whether or not the reciprocating action recognizing unit 321 has recognized a reciprocating action, the determining unit 316 determines the operation mode. Meanwhile, when an object is in the operation mode selectable state, the determining unit 316 can be configured not to receive a sweeping action or a reciprocating action. Alternatively, when an object is in the operation mode selectable state, the determining unit 316 can receive only a reciprocating action. Still alternatively, when an object is in the operation mode selectable state, the determining unit 316 can receive a sweeping action or a reciprocating action and interpret that action in a different manner when action recognition is done in the operation mode selectable state than when action recognition is done in the normal state.

For example, with reference to the example illustrated in FIG. 15, when a sweeping action is recognized in the normal state, the window 1302 and the objects 1303 to 1306 arranged in the window 1302 are moved in the direction of sweeping. Moreover, when a sweeping action is recognized in a state in which a selection action has been performed with respect to the window 1302, then the window 1302 and the objects 1303 to 1306 arranged in the window 1302 are moved in the direction of sweeping. However, when a sweeping action is recognized in a state in which a selection action has been performed with respect to an object from among the objects 1303 to 1306, then only the selected object is moved in the direction of sweeping. Meanwhile, as described in the earlier embodiments, when a cancellation gesture (such as a reciprocating action) is recognized in the operation mode selectable state, then the object can be switched to the normal state.

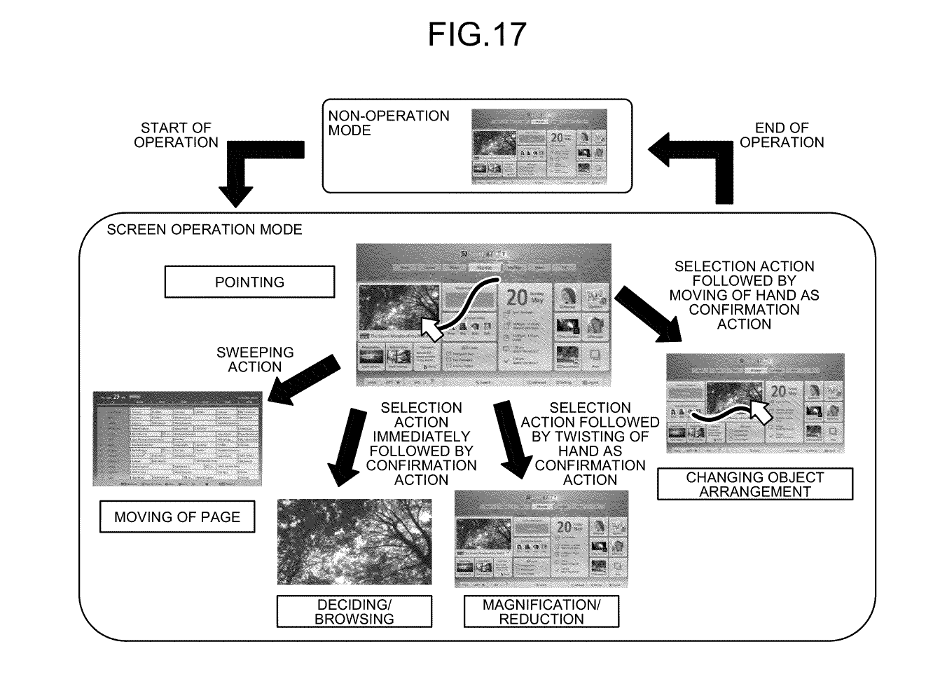

FIG. 17 is a diagram illustrating an exemplary operation image according to the third embodiment. With reference to FIG. 17, the explanation is given for an example in which a television is operated. As illustrated in FIG. 17, to start with, the television is in the non-operation mode. During the non-operation mode, none of the following is performed: calculating the pointer position; performing a selection action; performing a confirmation action; and determining the operation mode. When the operation start recognizing unit 318 recognizes that a start action has been performed, there occurs transition to a screen operation mode in which various gestures made by the user are recognized. In the screen operation mode, when the operation end recognizing unit 319 recognizes that an end action has been performed, there occurs transition to the non-operation mode.

As far as the method implemented by the operation start recognizing unit 318 for determining a start action is concerned; in the state in which the start action is not recognized, when the tilt of the specific body part becomes more upward than a predetermined operation start threshold angle, the operation start recognizing unit 318 recognizes that a start action has been performed. In contrast, as far as the method implemented by the operation end recognizing unit 319 for determining an end action is concerned; in the state in which the end action is not recognized, when the tilt of the specific body part becomes more downward than a predetermined operation end threshold angle, the operation end recognizing unit 319 recognizes that an end action has been performed. For example, the operation start threshold angle is set to be 20° in the upward direction from the horizontal level, while the operation end threshold angle is set to be 20° in the downward direction from the horizontal level. Alternatively, if the tilt of the hand reaches the operation start threshold angle or the operation end threshold angle before coming to rest, then it can be determined that a start action or an end action is performed. At that time, for a predetermined percentage of time within a predetermined period of time in the past, if the movement of the position of the pointer is within a predetermined range, then it can be determined that the tilt of the hand has come to rest.

From the temporal changes in the position of the pointer as calculated by the calculator 314, the sweeping action recognizing unit 320 and the reciprocating action recognizing unit 321 recognize the respective actions. Those actions can be recognized in the following manner. More particularly, based on the temporal changes in the position of the pointer as calculated by the calculator 314; from the change in the sign of the inner product of an action vector of the specific body part and a predetermined coordinate axis vector, a feature is calculated in the form of the number of times of an action for which the period of time till the next change is within a predetermined period of time is performed in succession. For example, as the feature is calculated as the number of times of a hand action in which one turn-around point to the next turn-around point is travelled within a predetermined period of time of 350 ms. That is, when the user performs a reciprocating action of a hand such as waving a hand from side to side, the number of times of turning the hand back during the reciprocating action within a predetermined period of time is calculated as the feature.

Then, it can be determined whether the number of times of turning the hand back during the reciprocating action (for example, four times) is greater or smaller than the predetermined number of times. Depending on the determination result, the gesture made by the user can be classified and the corresponding processing can be performed. That is due to the fact that the movement of the position of the pointer due to a sweeping action of a hand and a reciprocating action of the hand are similar gestures. As a result, it becomes possible to prevent a situation in which the processing corresponding to a sweeping action as well as the processing corresponding to a reciprocating action is performed in response to a sweeping action or in response to a reciprocating action.

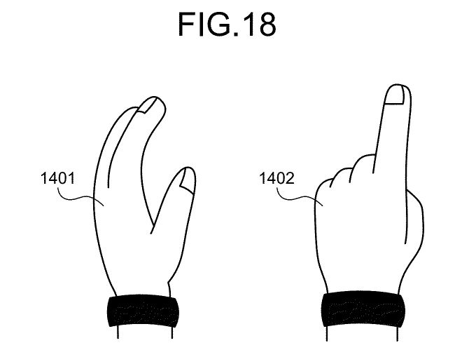

Aside from this, by using the tilt of the hand, a sweeping action can be distinguished from a reciprocating action or a pointing action. FIG. 18 is a diagram illustrating an example in which a hand of the user is viewed from above. For example, as illustrated in FIG. 18, when the user performs a hand sweeping action, it is often the case that the action is sideways as illustrated using a hand 1401. In contrast, when the user performs a pointing action or a reciprocating action, it is often the case that the action is not that sideways as illustrated using a hand 1402.

Thus, from the tilt of the hand at the time when the user starts a gesture, if the action has a tilt equal to or greater than a predetermined angle, then it is determined that a sweeping action is performed. However, if the action has a tilt not equal to or greater than the predetermined angle, then it is determined that a pointing action or a reciprocating action is performed. Regarding the determination details, distinction between a sweeping action and a reciprocating action may not be performed using a threshold value. Alternatively, an evaluation value can be set based on the following: the magnitude of the amount of change in the tilt of the hand; the speed of the action of the hand representing the magnitude of the temporal changes in the position of the pointer; and the degree of reciprocation per hour. Then, the distinction can be performed using the magnitude of the evaluation value.

Meanwhile, as far as a reciprocating action is concerned, there is also the possibility of what is called a bye-bye action. In the case of a bye-bye action, it is often the case that the action is performed while showing the palm to the target for operations. Hence, it is believed that the angle of rotation in the vertical direction of the specific body part has a substantially upward orientation than the horizontal level. Thus, for example, when the angle of rotation in the vertical direction is greater than a predetermined threshold value, then the action can be determined to be a bye-bye action. In any other condition, the action can be determined to be either a pointing action or a reciprocating action other than a bye-bye action. Regarding the determination details, distinction between a sweeping action and a reciprocating action may not performed using a threshold value. Alternatively, an evaluation value can be set based on the following: the magnitude of the amount of change in the tilt of the hand; the speed of the action of the hand representing the magnitude of the temporal changes in the position of the pointer; and the extent of reciprocation per hour. Then, the distinction can be performed using the magnitude of the evaluation value.

In the third embodiment, the start or the end of an operation with respect to an object is recognized based on the tilt of the specific body part. Moreover, a sweeping action and a reciprocating action are distinguished based on the temporal changes in the position of the pointer and the amount of change in the tilt of the specific body part. According to the third embodiment, it not only becomes possible to enhance the operability at the time of performing processing corresponding to the recognized action, but also becomes possible to recognize the user action in a more accurate manner.

### Fourth Embodiment

Till now, the explanation is given for the embodiments of a recognition device. However, aside from those embodiments, various other illustrative embodiments can also be implemented. There, given below is the explanation of different embodiments regarding (1) operation image, (2) scroll operation, (3) other use cases, (4) operation by a plurality of people, (5) configuration, and (6) computer program.

(1) Operation Image

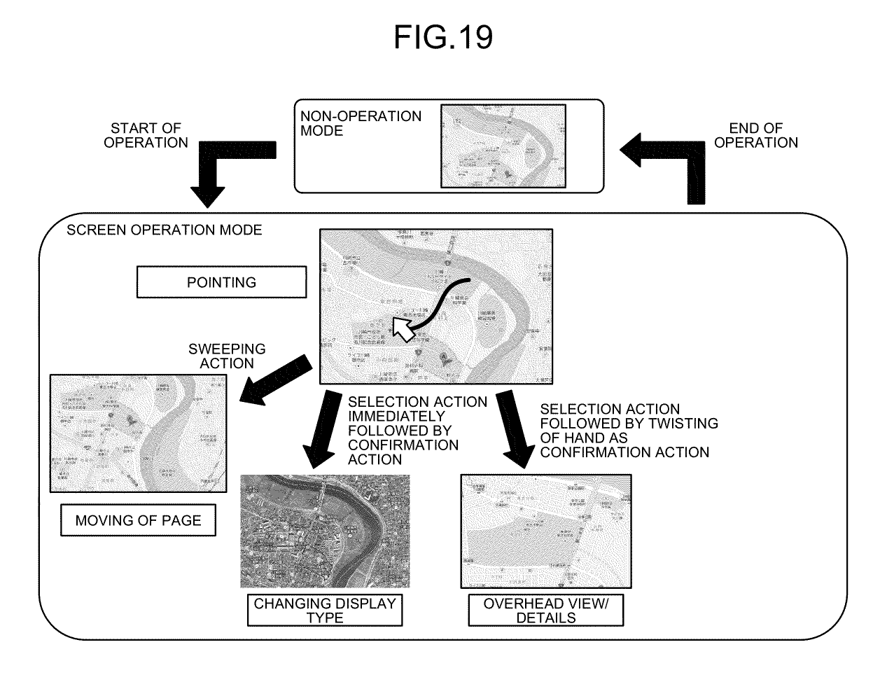

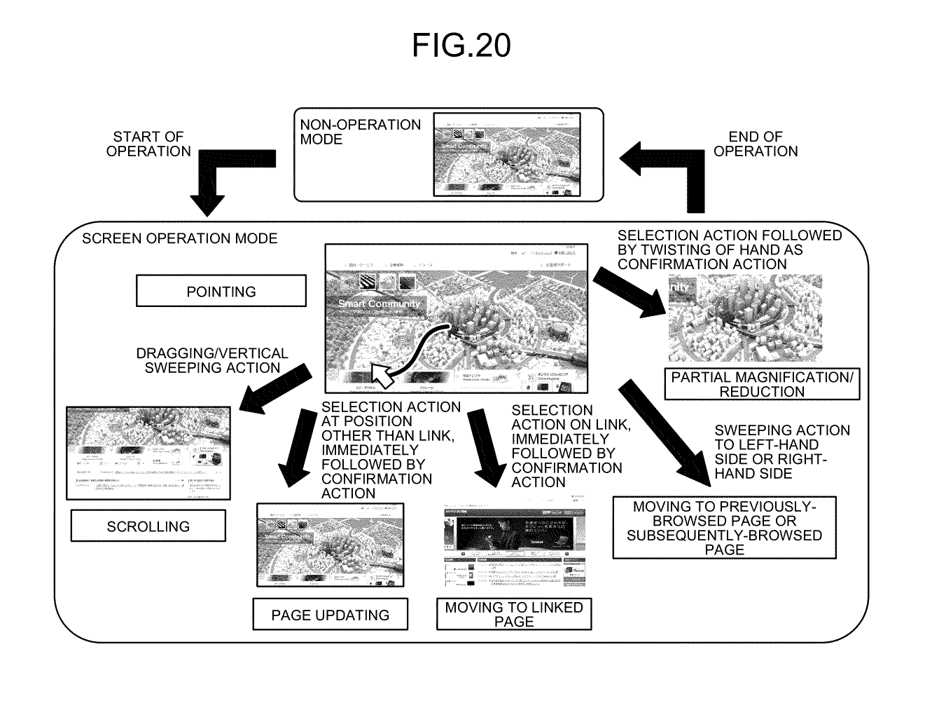

In the embodiments described above, an operation image is explained with reference to FIG. 17. However, that is not the only possible operation. FIGS. 19 and 20 are diagrams illustrating examples of operation images according to a fourth embodiment.

In FIG. 19 is illustrated an operation image in the case in which the object type is map. As illustrated in FIG. 19, in the case in which an object represents a map, when a dragging action or a sweeping action is performed, then the configuration can be such that the page of the map is moved. Moreover, if the recognition of a selection action is immediately followed by a confirmation action, then the configuration can be such that the display type of the map is changed. Furthermore, if the recognition of a selection action is followed by twisting a hand as a gesture for a confirmation action, then the configuration can be such that an overhead view of the map is displayed or the details of the map are displayed.

In FIG. 20 is illustrated an operation image in the case in which the object type is Web page. As illustrated in FIG. 20, in the case in which an object represents a Web page, when a dragging action or a sweeping action is performed, then the configuration can be such that the Web page becomes scrollable. Moreover, if the recognition of a selection action at a position other than the link is immediately followed by a confirmation action, then the configuration can be such that an operation of updating the present Web page is performed. Furthermore, if the recognition of a selection action on the link is immediately followed by a confirmation action, then the configuration can be such that the Web page is switched to the linked Web page. Moreover, if a sweeping action to either the left-hand side or the right-hand side is performed, then the configuration can be such that the Web page is switched to the previously-browsed Web page or the subsequently-browsed Web page. Furthermore, if the recognition of a selection action is followed by twisting a hand as a gesture for a confirmation action, then the configuration can be such that partial magnification or partial reduction is performed.

(2) Scroll Operation

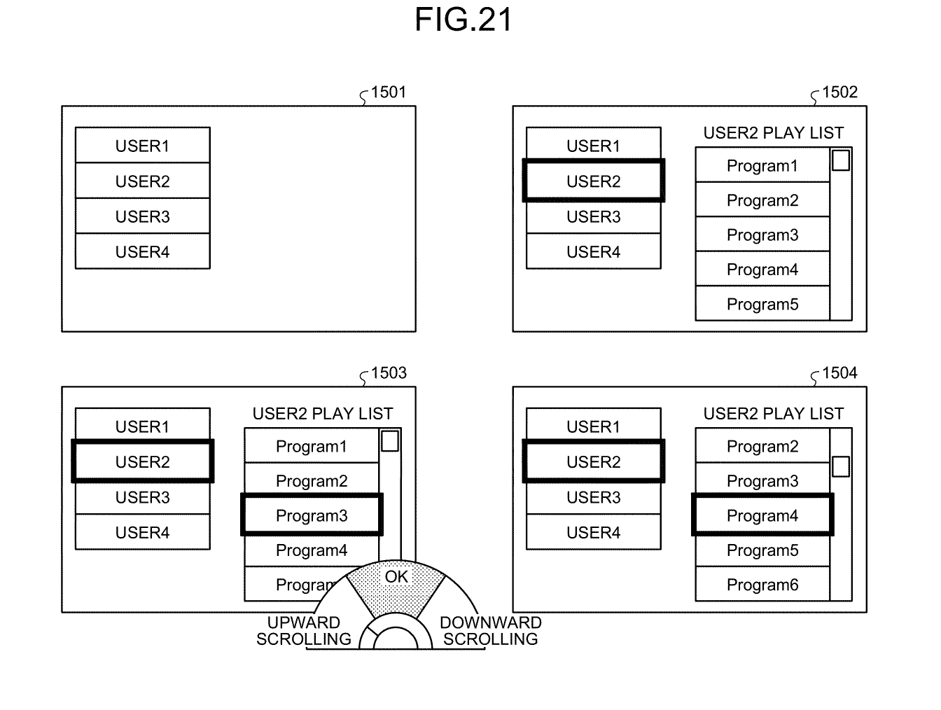

As far as a scroll operation is concerned, it is also possible to implement the operation explained below. FIG. 21 is a diagram for explaining an example of a scroll operation according to the fourth embodiment. In FIG. 21 is illustrated an example in which a favorite program is selected from a playlist of a user.

As illustrated in FIG. 21, an object 1501 represents an initial state. In the object 1501, a list of each user is displayed. Then, a user performs finger snapping and selects the corresponding user display location. As a result, as illustrated in an object 1502, the playlist of that user (for example, “USER2”) gets displayed. Then, the user performs finger snapping on the display location of the displayed playlist. As a result, as illustrated in an object 1503, a frame is displayed near the center of the playlist (for example, displayed at “Program3”), as well as an indicator is displayed.

Then, if the user selects “OK”, he or she becomes able to browse “Program3”. Alternatively, if the user twists the hand, then scrolling in either the upward direction or the downward direction is performed. Herein, greater the extent of twisting the hand, greater is the scrolling speed. As a result of scrolling, as illustrated in an object 1504, “Program3” changes to “Program4”, and accordingly there occurs a change in a frame and a scroll bar.

(3) Other Use Cases

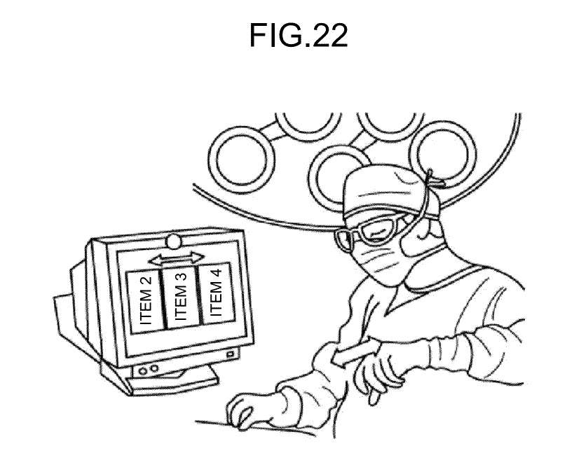

Meanwhile, aside from the use case such as a PC or a TV as explained above in the embodiments, it is possible to implement the recognition device in, for example, a medical terminal device. FIG. 22 is a diagram for explaining an example of implementing the recognition device in a medical information terminal. In the information terminal illustrated in FIG. 22, the recognition device according to one of the embodiments described above is mounted and is used in providing information to a doctor during a surgery. The doctor wears a measuring device to a specific body part such as a wrist. During a surgery, since it is desirable that the doctor keeps the hands clean, it is not desirable for him or her to directly touch an information terminal that provides information such as monitoring information or test results of the patient.

In that regard, if the recognition device according to any one of the embodiments described above is implemented in the information terminal, it becomes possible for the doctor to operate the information terminal in a contactless manner using hand gestures. Based on the measured values obtained from the measuring device that is attached to the specific body part of the doctor, the recognition device installed in the information terminal recognizes a gesture and executes a command for instructing the information terminal to scroll in the direction of the gesture or to execute a command for changing the display information.

Meanwhile, the application of the recognition device is not limited to a PC, a television receiver, or a medical information terminal. Alternatively, the recognition device can also be implemented in other types of devices such as a gaming device. Thus, regarding a gesture interface that enables a user to easily operate functions without having to hold a remote controller, a sensor, or a marker; the gesture interface can be implemented in a device in which it is possible to perform operations to change the menu for device control or to change the displayed contents.

(4) Operation by a Plurality of People

It is also possible to enable a plurality of users to perform operations. For example, in the case in which a plurality of users perform operations, identification information can be assigned in advance in order of switches attached to measuring devices or in order of activation of the measuring devices, and only the user who is wearing the measuring device corresponding to the initially-assigned identification information can be allowed to perform an operation. Alternatively, instead of allowing only one user to perform operations, a pointer corresponding to each of a plurality of users can be displayed so that each user can perform an operation. At that time, if a plurality of users attempts to perform an operation with respect to the same object, then only the user who initially performed the selection action with respect to that object can be allowed to perform the operation.

Meanwhile, a user may attach the measuring devices on both wrists. In this case, the measuring devices attached by each user can be recognized by means of pairing, and each user can be allowed to perform an operation based on the measured values obtained from each sensor. Alternatively, the measured values of only one of the two measuring devices can be considered valid. Still alternatively, the measured values of a plurality of measuring devices can be used; and, for example, depending on the changes in the relative distance between two measuring devices, magnification or reduction can be performed by means of what is called pitch-in or pitch-out.

Configuration

The processing procedures, the control procedures, specific names, various data, and information including parameters described in the embodiments or illustrated in the drawings can be changed as required unless otherwise specified. The constituent elements of the device illustrated in the drawings are merely conceptual, and need not be physically configured as illustrated. The constituent elements, as a whole or in part, can be separated or integrated either functionally or physically based on various types of loads or use conditions.

For example, in the embodiments described above, the explanation is given for a recognition device that obtains measured values from a measuring device attached to a specific body part such as a wrist of a user, that recognizes a gesture of the user based on the measured values, and that gives feedback about the operation with respect to the target for operations and about the operation state. However, this recognition device can be configured in an integrated manner with the measuring device. That is, it is possible to have a wearable terminal device that is equipped with the functions of the recognition device explained above in the embodiments as well as includes sensors. Such a terminal device outputs the processing result to an information processing device that displays the target for operations. At that time, as far as the hardware configuration of the terminal device is concerned, sensors can be added to the hardware configuration illustrated in FIG. 1.

Meanwhile, the functions of the recognition device described above in the embodiments can be implemented using at least a single information processing device that is connected to a network. For example, the operations of the recognition device can be implemented using an information processing device that includes the functions of the obtaining unit 111, the calculator 214, the selection action recognizing unit 112, and the output unit 113; and using an information processing device that includes the functions of the confirmation action recognizing unit 215, the determining unit 216, and the executing unit 217.

Meanwhile, the measured values need not be measured by a dedicated measuring device. Alternatively, it is possible to use the measured values measured by the sensor installed in a commercially available smartphone. In that case, in an identical manner to the embodiments described above, the smartphone can be attached to a wrist of a user and can be made to output measured values to the recognition device.

(6) Computer Program

A recognition program executed in the recognition device is recorded in the form of an installable or an executable file in a computer-readable storage medium such as a compact disk read only memory (CD-ROM), a flexible disk (FD), a compact disk (CD), or a digital versatile disk (DVD), and provided as a computer program product. Alternatively, the recognition program executed in the recognition device can be saved as a downloadable file on a computer connected to the Internet or can be made available for distribution through a network such as the Internet. Still alternatively, the recognition program executed in the recognition device can be stored in advance in a read only memory (ROM) or the like.

The recognition program executed in the recognition device contains modules for implementing each of the abovementioned constituent elements (the obtaining unit 111, the selection action recognizing unit 112, and the output unit 113). In practice, for example, a central processing unit (CPU) loads the recognition program from a storage medium and runs it so that the recognition program is loaded in a main storage device. As a result, the obtaining unit 111, the selection action recognizing unit 112, and the output unit 113 are generated in the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recognition device comprising:
an obtaining unit configured to obtain a measured value according to an action of a target for measurement, the measured value being measured by a measuring device attached to a specific body part of the target for measurement;
a selection action recognizing unit configured to, based on an acceleration of the specific body part as obtained from the measured value, recognize that a selection action has been performed for selecting any one target for operations included in a screen area; and
an output unit configured to, in a state in which the selection action has been performed, output information about an operation state of the target for operations based on an amount of change in a tilt of the specific body part as obtained from the measured value.

2. The device according to claim 1, wherein the output unit is configured to output, as information about the operation state of the target for operations, selectability information that indicates whether an operation mode is in a selectable state, the operation mode representing a type of processing to be performed with respect to the target for operations.

3. The device according to claim 1, wherein the output unit is configured to output, as information about the operation state of the target for operations, processing information that indicates information about executable processing in a state in which an operation mode is in a selectable state, the operation mode being a type of processing to be performed with respect to the target for operations.

4. The device according to claim 3, wherein the output unit is configured to output the processing information that is set according to a magnitude of the amount of change in the tilt of the specific body part.

5. The device according to claim 3, wherein the output unit is configured to output the processing information that is changed according to a magnitude of the amount of change in the tilt of the specific body part.

6. The device according to claim 1, wherein the output unit is configured to output the operation state based on an elapsed time since carrying out the selection action.

7. The device according to claim 1, wherein the output unit is configured to output elapsed time information that indicates, in the form of a relative value, an elapsed time till an end time at which an executable state of an operation with respect to the target for operations ends.

8. The device according to claim 1, further comprising:
a calculator configured to calculate a pointed position in the screen area based on the tilt of the specific body part;
a confirmation action recognizing unit configured to recognize that a confirmation action has been performed for confirming that an operation is to be performed with respect to the target for operations which is selected;
a determining unit configured to, in a state in which the confirmation action has been performed, determine an operation mode based on an amount of change in the tilt of the specific body part, the operation mode being a type of processing to be performed with respect to the target for operations; and
an executing unit configured to perform processing with respect to the target for operations corresponding to the pointed position according to the operation mode that is determined, wherein
the selection action recognizing unit is configured to recognize that the selection action has been performed for selecting the target for operations corresponding to the pointed position.

9. The device according to claim 8, wherein the determining unit is configured to determine the operation mode based on an elapsed time since carrying out the selection action till carrying out the confirmation action.

10. The device according to claim 8, wherein the executing unit is configured to switch an executable state of an operation with respect to the target for operations to a non-executable state of operations with respect to the target for operations when the confirmation action is not recognized since the recognition of the selection action till an end time at which the executable state of the operation with respect to the target for operations ends, or, when next processing is not performed since processing according to the operation mode is performed till the end time.

11. The device according to claim 8, wherein the determining unit is configured to determine the operation mode based on a magnitude relationship between the amount of change in the tilt of the specific body part since carrying out the selection action till carrying out the confirmation action and a plurality of angles set as boundaries for switching a plurality of operation modes.

12. The device according to claim 8, wherein the determining unit is configured to determine the operation mode based on a magnitude relationship between an elapsed time since carrying out the selection action till carrying out the confirmation action and a predetermined amount of time that is shorter than an end time at which an executable state of an operation with respect to the target for operations ends.

13. The device according to claim 8, wherein the determining unit is configured to determine the operation modes that are different from each other according to the pointed position or according to a type of the target for operations corresponding to the pointed position.

14. The device according to claim 8, wherein the determining unit is configured to determine the operation mode that is magnification, reduction, or movement of the target for operations.

15. The device according to claim 8, further comprising:
an operation start recognizing unit configured to, based on the tilt of the specific body part, recognize that a start action has been performed for starting an operation with respect to the target for operations; and
an operation end recognizing unit configured to, based on the tilt of the specific body part, recognize that an end action has been performed for ending an operation with respect to the target for operations, wherein
the calculator is configured to perform processing to calculate the pointed position during a period of time starting from recognition of the start action till recognition of the end action.

16. The device according to claim 15, wherein the calculator is configured to calculate the pointed position as a relative position of the screen area in such a way that the tilt of the specific body part at the time of recognition of the start action corresponds to a predetermined position of the screen area.

17. The recognition device according to claim 15, wherein
the operation start recognizing unit is configured to recognize that the start action has been performed when the tilt of the specific body part becomes more upward than a predetermined angle in a state in which it is not recognized that the start action has been performed, and
the operation end recognizing unit is configured to recognize that the end action has been performed when the tilt of the specific body part becomes more downward than the predetermined angle in a state in which it is not recognized that the end action has been performed.

18. The device according to claim 8, further comprising:
a sweeping action recognizing unit configured to, based on at least one of temporal changes in the pointed position and the amount of change in the tilt of the specific body part, recognize that a sweeping action has been performed for sweeping the specific body part; and
a reciprocating action recognizing unit configured to, based on at least one of temporal changes in the pointed position and the amount of change in the tilt of the specific body part, recognize that a reciprocating action has been performed for moving the specific body part back and forth, wherein
the determining unit is configured to determine the operation mode based on at least one of whether the sweeping action has been performed and whether the reciprocating action has been performed.

19. The device according to claim 18, wherein
the sweeping action recognizing unit is configured to distinguish the sweeping action from the reciprocating action according to a magnitude relationship between the amount of change in the tilt of the specific body part with respect to a predetermined reference angle and a predetermined threshold angle, and
the reciprocating action recognizing unit is configured to distinguish the reciprocating action from the sweeping action according to a magnitude relationship between the amount of change in the tilt of the specific body part with respect to a predetermined reference angle and a predetermined threshold angle.

20. The device according to claim 18, wherein
the sweeping action recognizing unit is configured to distinguish the sweeping action from the reciprocating action according to a magnitude relationship between an amount of change in an angle of rotation in the vertical direction of the specific body part with respect to a predetermined reference angle and a predetermined threshold angle, and
the reciprocating action recognizing unit is configured to distinguish the reciprocating action from the sweeping action according to a magnitude relationship between an amount of change in an angle of rotation in the vertical direction of the specific body part with respect to a predetermined reference angle and a predetermined threshold angle.

21. The device according to claim 8, wherein the selection action recognizing unit is configured to recognize that the selection action has been performed when an amount of change in the acceleration of the specific body part is equal to or greater than a first threshold value and when an amount of change in the acceleration of the specific body part around the time with reference to a time at which an amount of change in the acceleration of the specific body part becomes equal to the first threshold value is smaller than a second threshold value that is determined depending on the first threshold value and that is smaller than the first threshold value.

22. The device according to claim 21, wherein the selection action recognizing unit is configured to recognize that the selection action has been performed when a change in the pointed position around the time with reference to a time at which an amount of change in the acceleration of the specific body part becomes equal to the first threshold value is within a predetermined range.

23. The device according to claim 8, wherein the executing unit is configured to perform an operation to display the related target for operations when a selected target for operations expands to a target for operations related thereto.

24. A recognition method comprising:
obtaining a measured value according to an action of a target for measurement, the measured value being measured by a measuring device attached to a specific body part of the target for measurement;
recognizing, based on an acceleration of the specific body part as obtained from the measured value, that a selection action has been performed for selecting any one target for operations included in a screen area; and
outputting, in a state in which the selection action has been performed, information about an operation state of the target for operations based on an amount of change in a tilt of the specific body part as obtained from the measured value.

25. A computer program product comprising a computer-readable medium containing a program executed by a computer, the program causing the computer to execute:
obtaining a measured value according to an action of a target for measurement, the measured value being measured by a measuring device attached to a specific body part of the target for measurement;
recognizing, based on an acceleration of the specific body part as obtained from the measured value, that a selection action has been performed for selecting any one target for operations included in a screen area; and
outputting, in a state in which the selection action has been performed, information about an operation state of the target for operations based on an amount of change in a tilt of the specific body part as obtained from the measured value.

26. A terminal device comprising:
a measuring device attached to a specific body part of a target for measurement and configured to measure a measured value according to an action of the target for measurement;
an obtaining unit configured to obtain the measured value;
a selection action recognizing unit configured to, based on an acceleration of the specific body part as obtained from the measured value, recognize that a selection action has been performed for selecting any one target for operations included in a screen area; and
an output unit configured to, in a state in which the selection action has been performed, output information about an operation state of the target for operations based on an amount of change in a tilt of the specific body part as obtained from the measured value.
